(19) United States
(12) Patent Application Publication
(10) Pub. No.: US 2015/0278769 A1
(43) Pub. Date: Oct. 1, 2015

(54) EVENT START TIME ESTIMATION AND NOTIFICATION SYSTEM

(71) Applicant: EBAY INC., San Jose, CA (US)

(72) Inventor: Kamal Zamer, Austin, TX (US)

(21) Appl. No.: 14/227,949

(22) Filed: Mar. 27, 2014

(51) Int. Cl. G06Q 10/10; G06N 5/04

(52) U.S. Cl. CPC G06Q 10/1095; G06N 5/04

(57) ABSTRACT

Systems and methods for estimating event start times include monitoring a plurality of customer devices that are located at a venue at which an event is occurring. When a media generation action is detected as having been performed within a time period on a subset of the plurality of customer devices, it is determined whether the subset of the plurality of customer devices that has performed the media generation action exceeds a minimum number of customer devices. If so, it is determined that a sub-event that is included in the event has started at a sub-event start time. Sub-event start times for a sub-event that is included in the event may be collected across a plurality of different occurrences of the event and used to estimate a sub-event start time for that sub-event for any subsequent occurrence of the event.

### BACKGROUND

1. Field of the Invention

The present disclosure generally relates to events, and more particularly to systems and methods for estimating event start times and providing notifications to customers of the event.

2. Related Art

More and more consumers are purchasing items and services over electronic networks such as, for example, the Internet. Consumers routinely purchase products and services from merchants and individuals alike. The transactions may take place directly between a conventional or on-line merchant or retailer and the consumer, and payment is typically made by entering credit card or other financial information. Transactions may also take place with the aid of an on-line or mobile payment service provider such as, for example, PayPal, Inc. of San Jose, Calif. Such payment service providers can make transactions easier and safer for the parties involved. Purchasing with the assistance of a payment service provider from the convenience of virtually anywhere using a mobile device is one main reason why on-line and mobile purchases are growing very quickly.

Tickets for live entertainment events may be purchased using online and/or mobile payment systems such as those provided above. Online marketplaces such as, for example, those provided by StubHub, a subsidiary of EBay Inc. of San Jose, Calif., may provide services for buyers and sellers of tickets for such live entertainment events, and payment provider systems may enable users to buy and/or sell those tickets to other users. However, the services provided by such payment service providers and online marketplaces are typically limited to the connecting of buyers and sellers of tickets and the providing for the purchase transactions for those tickets. The present disclosure contemplates several aspects of live entertainment events that may be improved using data collected by online marketplaces and/or payment service providers.

For example, one aspect of live entertainment events that is generally considered negative by customers of those live entertainment events occurs with regard to event start times. A customer of a live entertainment event will typically purchase a ticket for the live entertainment event that informs the customer of the scheduled start time of the event. However, such live entertainment events (or the customer-relevant portion of the live entertainment events) seldom actually start at the scheduled start time of the event. For example, music events may include a number of different performers, only one of which is the “headliner” or main attraction at the event. Many customers of the event only attend the event to watch the main attraction, but may feel the need to arrive at the event at the scheduled start time in order not to miss that main attraction. As such, the customers of the event may attend the event for a time period in which they do not need to be at the event.

Thus, there is a need for an event start time estimation and notification system.

### BRIEF DESCRIPTION OF THE FIGURES

FIG. 1 is a schematic top view illustrating an embodiment of an event venue;

FIG. 2 is a schematic view illustrating an embodiment of a beacon device;

FIG. 3a is a schematic top view illustrating an embodiment of an event start time estimation system that includes a plurality of the beacon devices of FIG. 2 in the event venue of FIG. 1;

FIG. 3b is a schematic top view illustrating an embodiment of the event start time estimation system of FIG. 3a with the beacon devices providing communication areas;

FIG. 4 is a flow chart illustrating an embodiment of a method for estimating event start times;

FIG. 5 is a schematic view illustrating an embodiment of an event start time estimation system;

FIG. 6a is a schematic top view illustrating an embodiment of customers located at the event venue of FIG. 1 prior to an event start time;

FIG. 6b is a schematic view illustrating an embodiment of location and orientation data retrieved for customers located at the event venue of FIG. 1 prior to an event start time;

FIG. 6c is a schematic view illustrating an embodiment of location and orientation data retrieved for customers located at the event venue of FIG. 1 upon or after an event start time;

FIG. 6d is a perspective view illustrating an embodiment of customers located at the event venue of FIG. 1 upon or after an event start time

FIG. 7 is a screen shot view illustrating an embodiment of an event update screen sent to a user device;

FIG. 8a is a screen shot view illustrating an embodiment of an event update screen sent to a user device;

FIG. 8b is a screen shot view illustrating an embodiment of an event update screen sent to a user device;

FIG. 9 is a schematic view illustrating an embodiment of a networked system;

FIG. 10 is a perspective view illustrating an embodiment of a customer device;

FIG. 11 is a schematic view illustrating an embodiment of a computer system; and

FIG. 12 is a schematic view illustrating an embodiment of a system provider device.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure provides systems and methods for estimating event start times and providing notifications of the estimated start times to customers. An event that that is scheduled to occur at one or more venues may include a plurality of sub-events and be associated with a scheduled start time or a plurality of scheduled start times. For any given occurrence of the event, a plurality of customer devices at the event may be monitored to detect when a media generation action is performed within a time period by a subset of the plurality of customer devices. If that subset of the plurality of customer devices exceeds a minimum number of customer devices, it may be determined that a sub-event included in the event has occurred at a sub-event start time, and that sub-event start time may then be stored in a database. Sub-event start times for any of the sub-events included in the event may be determined across the plurality of different occurrences of the event to determine average sub-event start times for each of the plurality of sub-events included in the event. This allows a sub-event start time to be estimated for any sub-event associated with a subsequent occurrence of the event, and that sub-event start time may be provided to customers of that subsequent occurrence of the event to notify those customers when sub-events included in the event are likely to occur. Thus, in embodiments where the event is a live music event that includes a plurality of performers, each performance by a performer may be considered a sub-event that is included in the event and for which an estimated sub-event start time may be determined. A customer that wishes to attend the live music event to see a particular performer may be notified when that particular performer is most likely to perform at the event, rather than being required to arrive at the event at the scheduled start time or guess when that performer will perform.

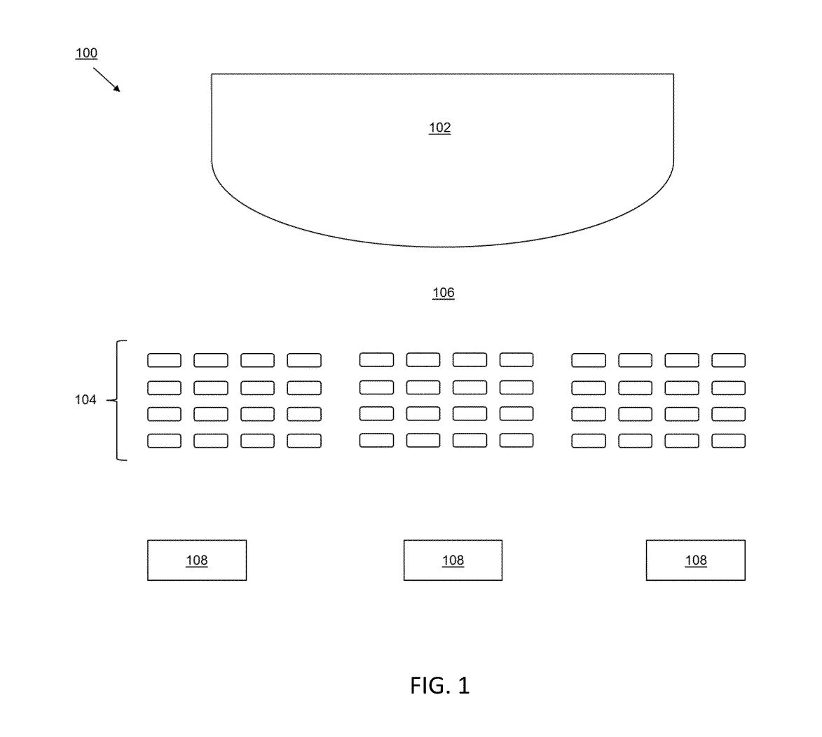

Referring now to FIG. 1, an embodiment of a venue 100 is illustrated. The illustrated embodiment of the venue 100 includes a stage 102, a seating area 104, a standing area 106 between the stage 102 and the seating area 104, and a plurality of vendor areas 108. As discussed in further detail below, the venue 100 provides for the occurrence of an event that includes a plurality of sub-events, and in particular, the embodiment of the venue 100 illustrated and described below provides for the occurrence of a live music event that includes a plurality of performers that are associated with performance sub-events included in the event. However, while the venue 100 is illustrated and described below as a live music venue providing for live music events, one of skill in the art in possession of the present disclosure will recognize that any venue including, for example, sporting venues, theater venues, presentation venues, and/or a variety of other venues at which associated events are held will fall within the scope of the present disclosure

In one example, sporting event venues may provide for sporting events that includes sub-events such as “heats” or other preliminary rounds of competition that may lead up to a championship competition or determine multiple teams that advance to a next level of competition (e.g., a track sporting event such as the United States Track & Field Championships; a racing sporting event such as a Formula 1 Grand Prix; a basketball sporting event such as a preliminary round of the National Collegiate Athletic Association (NCAA) Basketball tournament; etc.), or may include multiple discrete sporting contests during the sporting event (e.g., a boxing, wrestling, or mixed-martial arts sporting event with multiple undercards and a main event). In another example, theater event venues may provide for theater events that includes sub-events such as movie previews prior to a main showing, multiple acts of a play, etc. In another example, presentation venues may provide for presentation events that include multiple different speakers or panels on different subjects. In fact, even the music venue described herein may instead be a comedy venue that provides for a comedy event that includes comedy performers associated with comedy performance sub-events included in the comedy event. While a few examples of different events including sub-events have been provided, one of skill in the art in possession of the present disclosure will recognize that a wide variety of events will benefit from the present disclosure and thus will fall within its scope.

Furthermore, the term sub-event may refer to the actual time an event starts. For example, an event my include a scheduled start time, but may actually start at some time after that start time. In such an example, the sub-event may be the actual start time, and thus the actual start time of the event is a sub-event that occurs after the scheduled start time of the event. As such, the term “sub-event” used below may be any portion of the event that occurs after a scheduled start time, as well as multiple discrete portions of the event that occur during the occurrence of the event.

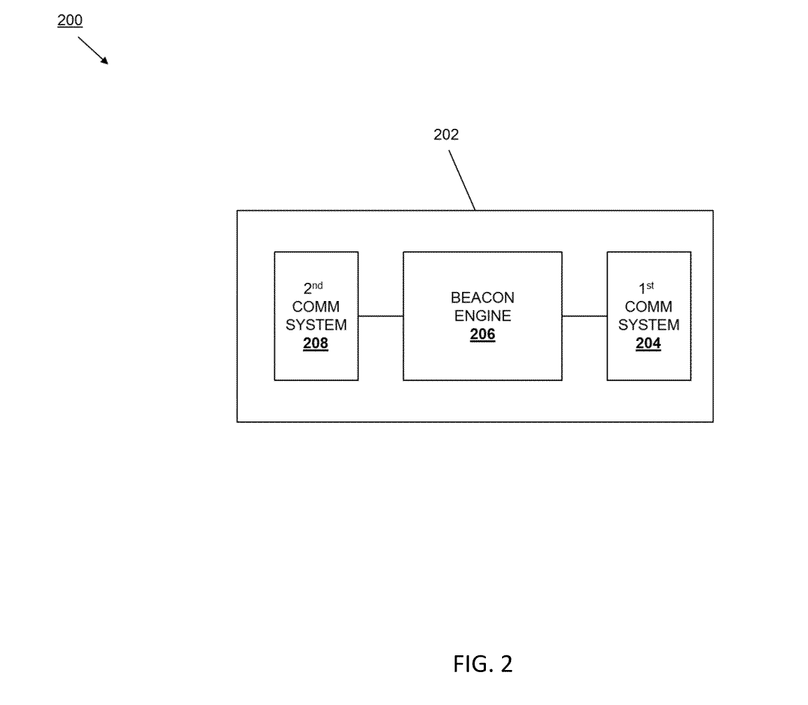

Referring now to FIG. 2, an embodiment of a beacon device 200 is illustrated. The beacon device 200 includes a chassis that houses a first communication system 204 such as, for example, a Wifi communication system. The first communication system 204 is coupled to a beacon engine 206 that may be provided by instructions on a memory system (not illustrated) in the beacon device 200 that, when executed by a processing system (not illustrated) in the beacon device 200, cause the processing system to perform the functions of the beacon devices 200 discussed below. The beacon engine 206 is coupled to a second communication system 208 such as, for example, a Bluetooth® Low Energy (BLE) communication system. The beacon engine 206 may be configured to receive any of a variety of sensor signals through the second communication system 208 and transmit those sensor signals using the first communication system 204. While a few examples of communication components in the beacon device 200 have been described, one of skill in the art will recognize that other communication devices, as well as other components that have been omitted for clarity of discussion and illustrated, may be included in the beacon device 200 and will fall within the scope of the present disclosure. One of skill in the art will recognize that the components described above allow for the beacon device to be provided in a relatively small form factor such that it may be placed inconspicuously almost anywhere. The chassis 202 of the beacon device 200 may include any of a variety of features that allow for the coupling of the beacon device to different areas in the venue 100, discussed below.

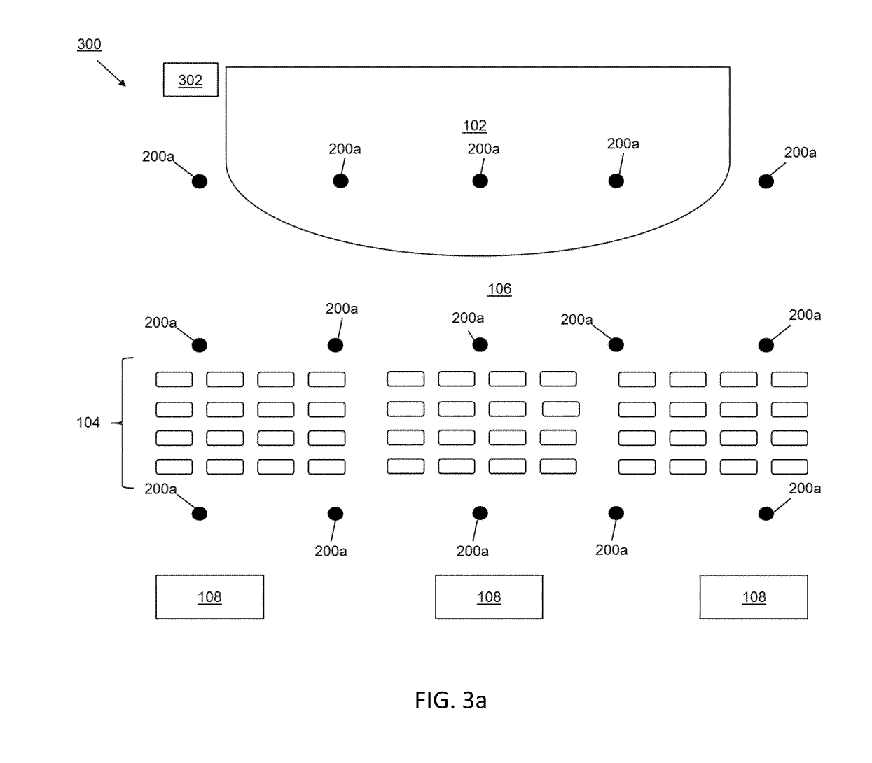

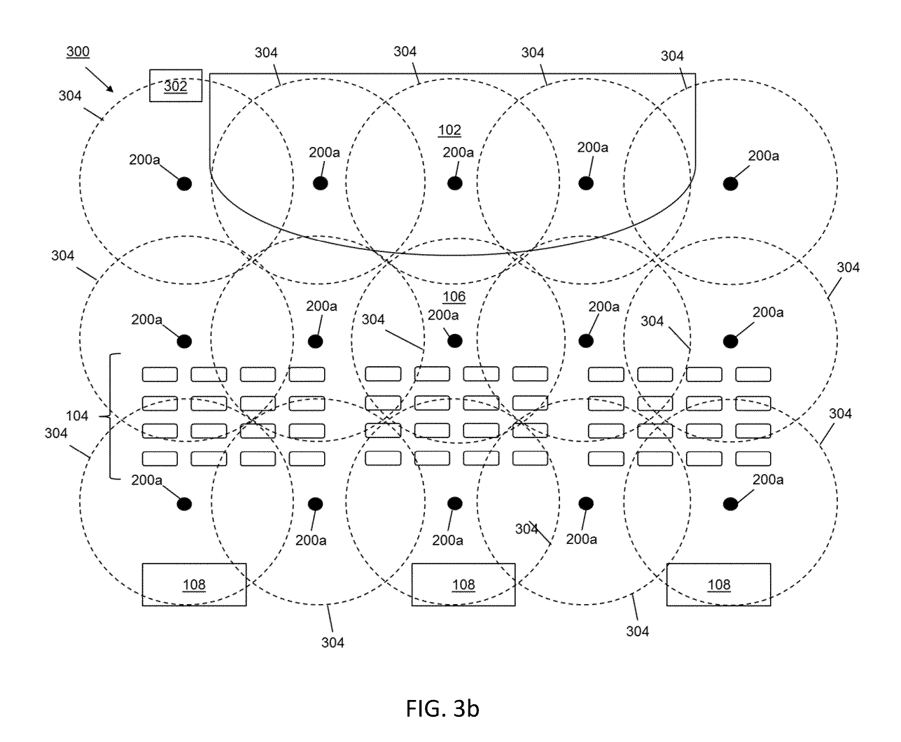

Referring now to FIGS. 3a and 3b, an embodiment of an event start time estimation system 300 is illustrated. As illustrated in FIG. 3a, the event start time estimation system 300 may be provided by positioning a plurality of the beacon devices 200, discussed above with reference to FIG. 2, in and around the venue 100, discussed above with reference to FIG. 1. In the illustrated embodiment, a plurality of beacon devices 200a is positioned in and around the venue 100. As discussed above, the beacon devices 200 may be sized such that they may be inconspicuously positioned virtually anywhere in or around the venue 100. For example, the beacon devices 200a may be positioned in the ceiling of the venue 100, in the floor of the venue 100, and/or elsewhere in the venue such that the beacon devices 200a are on and around the stage 102 of the venue 100, on and around the seating area 104 of the venue 100, on and around the standing area 106 of the venue 100, and on and around the vendor areas 108 at the venue 100. Each of the beacon devices 200a in the event start time estimation system 300 may be configured to wirelessly communicate, via its first communication system 204, with a venue operator network communication device 302 such as, for example, a Wifi wireless router connected to a network such as the Internet.

Referring now to FIG. 3b, in operation, each of the beacon devices 200a is configured to create a communication area 304 with its second communication system 204. For example, the second communication system 204 in each beacon device 200 may be BLE communication device that provides an approximately 100 foot radius communication area. However, other communication systems providing other communication areas are envisioned as falling within the scope of the present disclosure. As can be seen in the illustrated embodiment, the beacon devices 200a may be positioned in and around the venue 100 such that the communication areas 304 abut, overlap, or otherwise provide coverage for any area of interest within and around the venue 100. As such, one of skill in the art in possession of the present disclosure will appreciate that different configurations of the beacon devices 200a within and around the venue 100 may be selected to cover any area within and around the venue 100 with a communication area 304. As discussed in further detail below, each of the beacon devices 200a are configured to communicate with customer devices within their respective communication area 304 (e.g., using the second communication system 208) to collect data, and then send that data to the venue operator network communication device 302 (e.g., using the first communication system 204) such that the data may be provided to a payment system provider device, an online marketplace provider device, a venue operator device, a system provider device, and/or any other device operating to provide the event start time estimations discussed below. One of skill in the art will recognize that the use of BLE communication devices for communication between the beacon devices 200a and customer devices may be utilized to provide for low power communication in the background of a customer device (e.g., when the customer device is not being actively used by the customer or is being actively used for some purpose other than communicating with the beacon devices 200a (e.g., in the background of the customer device operating system)).

In the embodiments illustrated and discussed below, the beacon devices 200a and their communication areas 304 are not illustrated for clarity of illustration and discussed, but it should be understood that the communication and retrieval of information from beacon communication devices, and that provision of that information to a system provider device may be accomplished using beacon devices providing communication areas such as the beacon devices 200a and communication areas 304 illustrated in FIGS. 3a and 3b. However, in some embodiments, the beacon devices 200a may be omitted from the event start time estimation system 300 and any communication between the customer devices and the system provider devices discussed below may be provided over other networks (e.g., Local Area Networks (LANs), the Internet, etc.). Thus, while a specific example of an event start time estimation system 300 is provided, one of skill in the art in possession of the present disclosure will recognize that a wide variety of different venues may incorporate the beacon devices 200 or other types of communication systems in a variety of manners while remaining within the scope of the present disclosure.

In the embodiments discussed below, the event start time estimation systems and methods involve a system provider using a system provider device to retrieve information collected by the beacon devices 200a from customer devices through a network (e.g., the Internet). In such embodiments, the system provider may associate the venue 100 (or its associated venue operator), the event occurring at the venue, the sub-events included in the event, the beacon devices 200a, venue operator devices, and/or other components of the system with a venue account, an event account, a sub-event account, and/or other identifying accounts in a database located in a non-transitory memory. As such, information received from the beacon devices and venue operator devices may be associated with the venue account, event account, sub-event account, and/or other identifying account in the database, and any results of the analysis of that information may be stored in associated with that venue account, event account, sub-event account, and/or other identifying account. In other embodiments, the system provider device may include a venue operator device that is local to the venue 100 and that communicates with the beacon devices 200a using the venue operator network communication device 302.

FIGS. 1, 3a, and 3b illustrate a venue 100 that includes a single stage 102, and the beacon devices 200a are positioned to provide communication areas 304 that cover the areas around that single stage 102. However, beacon devices 200a may be positioned virtually anywhere to retrieve information associated with a venue. For example, the venue 100 may be located adjacent to or associated with a parking lot, and beacon devices may be positioned around that parking lot, at the entrances or exits of that parking lot, and/or anywhere else relative to that parking lot in order to collect and send information from beacon communication devices to the system provider device. In another example, the venue may be located in a stadium or areas with multiple stages, and beacon devices may be positioned around that stadium, at the entrances or exits of that stadium, and/or anywhere else relative to that stadium in order to collect and send information from beacon communication devices to the system provider device. In some examples, the first communication system may be connected to Wifi networks available outside the venue in order to communicate collected information to a system provider device. In other examples, the first communication system may be a cellular communication system that allows the beacon devices to be positioned anywhere in range of a cellular communication tower, allowing beacon devices to be positioned in virtually any physical location when providing the event start time estimation system.

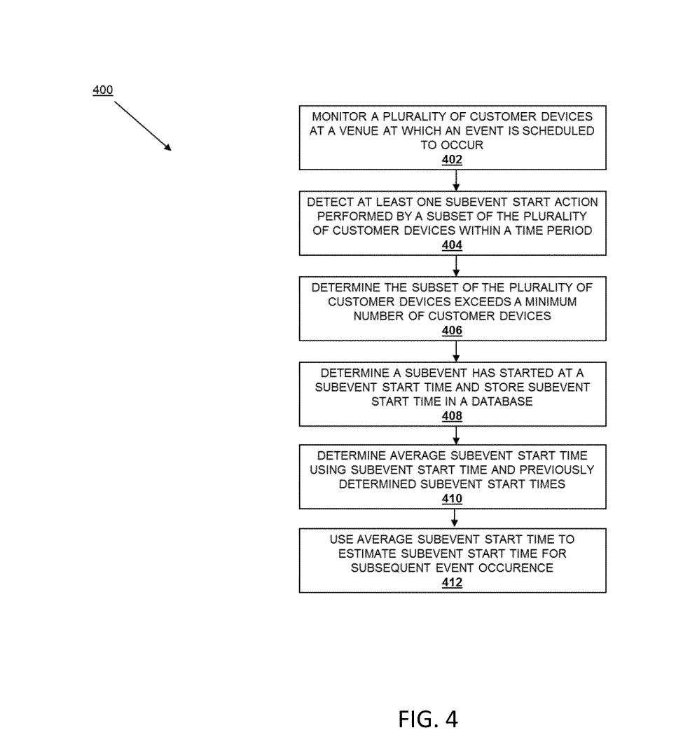

Referring now to FIG. 4, an embodiment of a method 400 for estimating event start times is illustrated. In an embodiment, the event start time estimation method 400 may be performed by a payment service provider such as, for example, PayPal Inc. of San Jose, Calif. that provides payment services for venues, events, customers, and other entities that allow transactions between those entities. In another embodiment, the event start time estimation method 400 may be performed by an online marketplace provider such as, for example, StubHub, a subsidiary of EBay, Inc. of San Jose, Calif. that provides an online marketplace for venues, events, customers, and other entities that allow transactions between those entities. In embodiments where the payment service provider or online marketplace provider provides the event start time estimation method 400, venue operator accounts, event accounts, sub-event account, customer accounts, and/or other identifying accounts may be used, for example, to identify venues, events, sub-events, customers, and/or other features of the system. However, in other embodiments, the event start time estimation method 400 may be performed by the venue operator, the event provider, and/or other system providers while remaining within the scope of the present disclosure. Thus, further references to a “system provider” are meant to include any combination of entities that operate to provide the event start time estimation system described herein and perform the event start time estimation method 400 discussed below.

In the embodiment illustrated and described below, the venue 100 is providing a music event that includes a plurality of performance sub-events by different performers. The music event may be associated with one or more scheduled start times that may be published by the event providers that may indicate when the music event starts, when the music event ends, when each performance sub-event starts, when each performance sub-event ends, and/or the timing of a variety of other sub-events that are included in the event. Furthermore, while performance sub-events included in the music event are the only types of sub-events discussed, any scheduled or unscheduled sub-event included in an event is envisioned as falling within the scope of the present disclosure. In an embodiment, the event schedule may be published or otherwise made available (e.g., over a network) to the system provider device by the event provider, the venue operator, a customer, and/or other participant in the system such that the system provider device may retrieve the event schedule and determine that the event and its sub-events are scheduled to occur. In some embodiments, scheduled start times and/or end times may be made available for the event and each of its sub-events. In some embodiments, scheduled start times and/or end times may be made available for only the event, and sub-events may be scheduled only by the name of the performer. In some embodiments, sub-events may not be advertised, but as discussed below the system provider device may use the methods described herein to detect a sub-event is occurring and determine what that sub-event is.

Prior to the method 400 discussed below, the customers having the customer devices may have purchased tickets to the event at the venue 100 using, for example, the online marketplaces, payment service providers, and/or system providers discussed above. As such, the system provider device may include a customer list (e.g., of customer accounts) that that includes customers that have purchased tickets to the event and thus are planning on attending the event. In some embodiments, during the event ticket purchasing process, the system provider device may request permission from the customers who purchase tickets to the event to access the customer devices during the method 400 as discussed below.

Referring now to FIGS. 4, 5, and 6a, the method 400 begins at block 402 where a plurality of customer devices is monitored at an event that is scheduled to occur. While the discussion below is directed towards scheduled events, in some embodiments of block 402, a plurality of customer devices in a common location may be monitored without an event being scheduled. One of skill in the art in possession of the present disclosure will recognize that the monitoring of customer devices in a common location, even without an event being scheduled such that an event schedule is available, provides for the retrieval of data from those customer devices that will allow the system provider device to determine both that a sub-event has started and what that sub-event is. As such, any of the discussion below is equally applicable to unscheduled events that the system provider device determines are occurring (e.g., based on the sub-event start actions discussed below) and identifies the details of (based on the data retrieved from the customer devices).

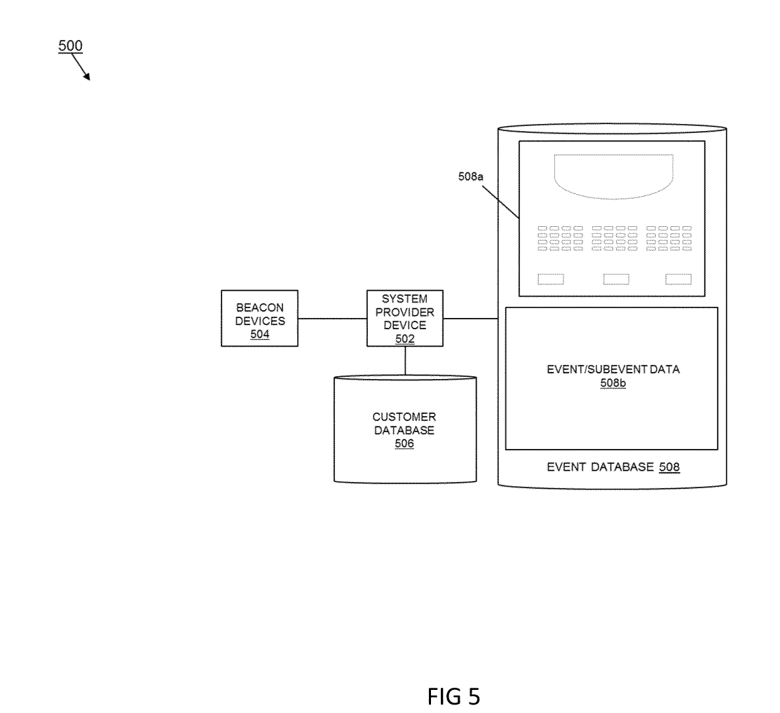

FIG. 5 illustrates an embodiment of the event start time estimation system 500 that includes a system provider device 502 coupled to the beacon devices 504, a customer database 506, and an event database 506. In the embodiment discussed below, the customer database 506 may include customer data such as, for example, customer account information that indicates customers that have purchased tickets to the event and/or any other customer information known in the art. In the embodiment discussed below, the event database 508 may include venue data 506a that describes the physical layout of the venue 100, event/sub-event data 508b that may include event schedules and/or any other information that is being collected or that has been previously collected about the events, sub-events, and/or venues. While a specific example of the event start time estimation system 500 is provided, one of skill in the art in possession of the present disclosure will recognize that other information may be stored and accessed by the event start time estimation system 500 depending on the type of event occurring while remaining within the scope of the present disclosure.

In an embodiment of block 402, the system provider device 502 may access the event/sub-event data 508b in the event database 508 to retrieve an event schedule and determine that the event occurring at the venue 100 is scheduled to occur. Furthermore, in some embodiments, the system provider device 502 may access the customer database 506 to determine customer accounts that have purchased tickets to the event occurring at the venue. In an embodiment, the customer accounts determined at block 402 to have purchased a ticket to the event occurring at the venue 100 may be associated with customer devices of the customers that will be attending the event occurring at the venue 100. In another embodiment, the determination that the event at the venue 100 is scheduled to occur may result in the system provider device attempting to access and monitor any customer device that is located at the venue 100 during the scheduled event (e.g., customers entering the venue 100 may be asked permission for the system provider device to access their customer devices).

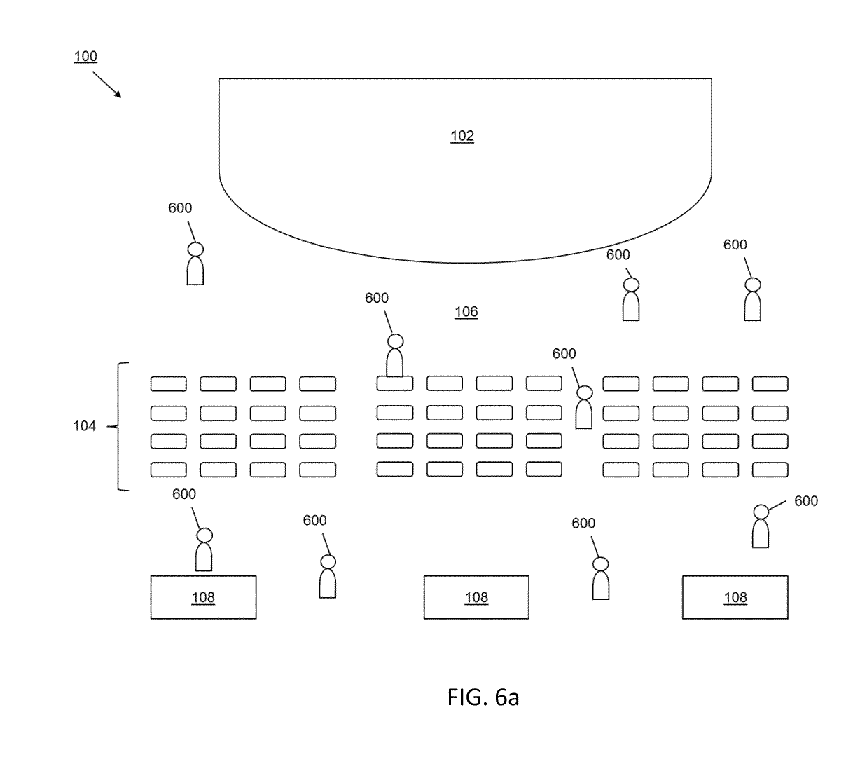

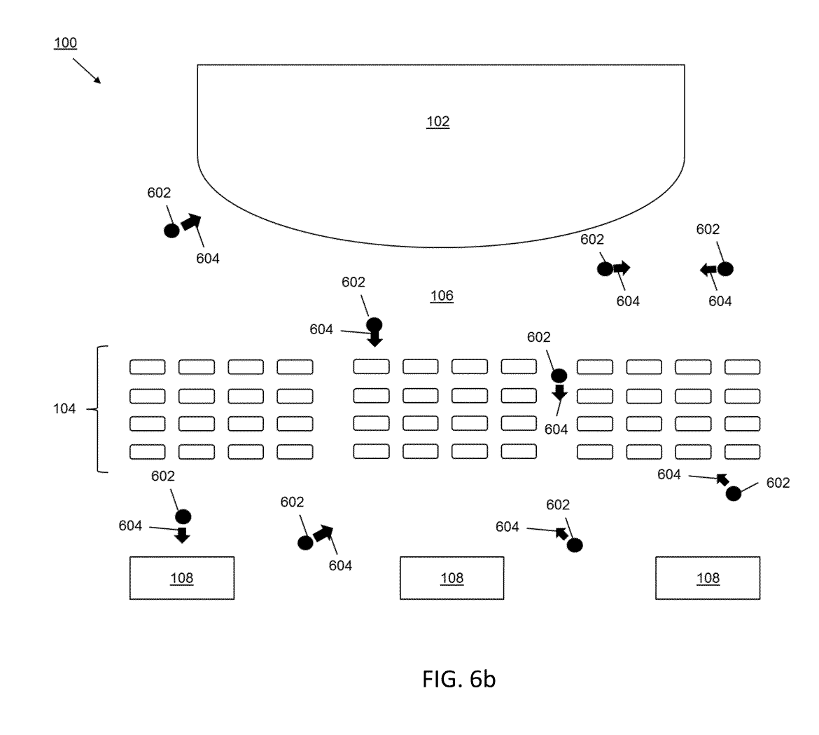

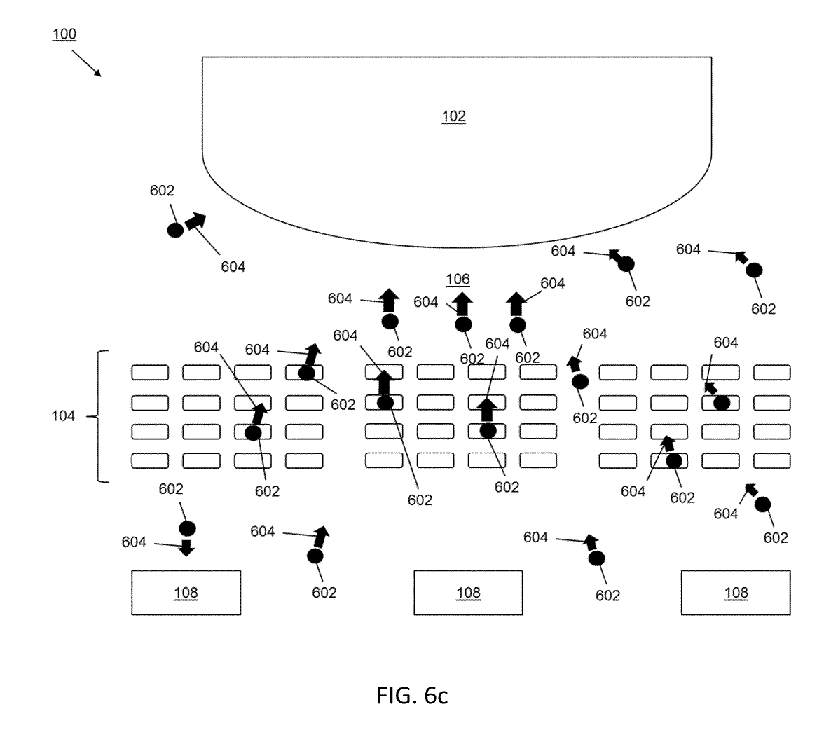

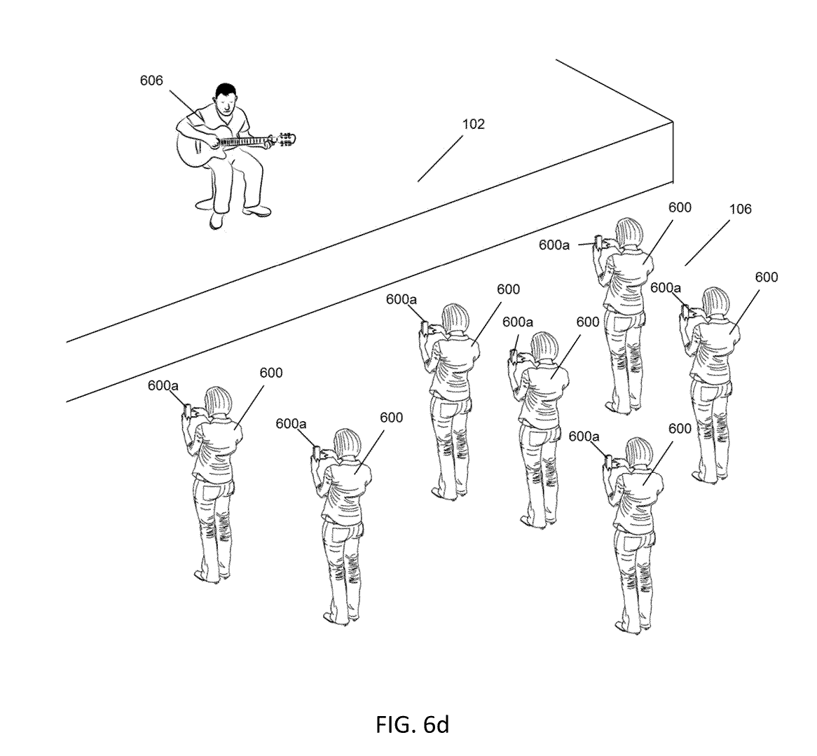

Thus, at block 402, the system provider device determines that the event is scheduled to occur at the venue 100, and determines a plurality of customer devices that are located at the venue 100 during the scheduled event. FIG. 6a illustrates the venue 100 including a plurality of customers 600 located at the venue 100. While not illustrated, any or all of the plurality of customers 600 may include a customer device such as, for example, a mobile phone, that may be monitored by the system provider device at block 402. In an embodiment, the system provider device may begin monitoring the respective customer devices upon each of the plurality of customers 600 entering the venue 100 (e.g., the customer devices may transmit location information to the system provider device that may allow the system provider device to determine when the customer device has entered the venue 100 and, in response, the system provider device may begin monitoring that customer device). However, the system provider device may begin monitoring the customer devices at any time prior to or upon the scheduled start time of the event while remaining within the scope of the present disclosure.

In an embodiment, the system provider device may monitor the customer devices of the plurality of customers 600 using the beacon system (discussed above) or other available network to retrieve a wide variety of information from the customer devices that may be utilized in the method 400. In one embodiment, the system provider device may monitor the customer devices of the plurality of customers 600 for location information. For example, the system provider device may retrieve location data from location determination devices (e.g., Global Positioning System (GPS) devices) in each of the plurality of customer devices at block 402 to determine the relative position of each of the plurality of customers 600 within the venue 100 (e.g., using the venue data 508a and location information from the customer devices). In another embodiment, the system provider device may monitor the customer devices of the plurality of customers 600 for orientation information. For example, the system provider device may retrieve orientation data from orientation determination devices (e.g., gyroscope devices, accelerometers, magnetic field sensors, etc.) in each of the plurality of customer devices at block 402 to determine the orientation of each of the plurality of customers 600 within the venue 100 (e.g., using the venue data 508a). In another embodiment, the system provider device may monitor the customer devices of the plurality of customers 600 for media generation actions. For example, the system provider device may detect media generation actions from media devices (e.g., cameras, microphones, etc.) in each of the plurality of customer devices at block 402 to determine whether a media generation action (e.g., capturing an image, capturing a video, zooming in with a camera lens, using a camera flash, capturing audio, and/or a variety of other media generation actions known in the art) has been performed by the plurality of customers 600. Furthermore, the system provider device may monitor any other sensor or device in the customer devices of the plurality of customers 600 including, for example, microphones (e.g., even when the user is not attempting to capture audio), temperature sensors, acceleration sensors, light sensors, and/or a variety of other sensors known in the art, in order to capture data for estimating event start times as discussed below.

Referring now to FIGS. 4, 6b, 6c, and 6d, the method 400 then proceeds to block 404 where at least one sub-event start action performed by a subset of the plurality of customer devices is detected within a time period. In an embodiment, the system provider device may define a time period within which, if a minimum number of customer devices performs a particular action or actions, it may be determined that a sub-event has occurred. For example, the time period may be 5-10 seconds, although time periods of a shorter or longer duration are envisioned as falling within the scope of the present disclosure and may depend on the sub-event that will be determined to have occurred based on that sub-event start action.

FIG. 6b illustrates a schematic visualization of a plurality of customer device monitoring data received by the system provider device from the customer devices of the plurality of customers 600 at the venue 100 that are illustrated in FIG. 6a. In an embodiment, FIG. 6b illustrates customer device monitoring data that is indicative of the plurality of customers 600 being located at the venue 100 for the music event prior to a performance sub-event (e.g., prior to any musical performances occurring). In the illustrated embodiment, the customer device monitoring data includes location data 602 and orientation data 604 from each customer device associated with a respective customer 600. As can be seen, the location data 602 indicates that many of the customers 600 are located throughout the venue 100 and, in particular, not many customers 600 are located in the seating area 104 or standing area 106 near the stage 102. As can also be seen, the orientation data 604 indicates that many of the customers 600 are not oriented towards the stage 102. The system provider device may interpret that lack of (or few) customers being located in the seating area 104 or standing area 106 near the stage 102, and/or the lack of (or few) customer being oriented towards the stage 102, as indicative of no performance sub-event occurring.

In some embodiments, customer device monitoring data retrieved from the customer devices of the plurality of customers 600 that are located at the venue 100 for the music event prior to a performance sub-event may also include a lack of, or limited number of, media generation actions being performed by the customer devices of the plurality of customers 600 (e.g., the number of customer devices performing media generation actions during a time period may be less than a minimum number of media generation actions). For example, a lack of (or few) customers attempting to capture images or video, particularly using customer devices that are oriented towards the stage 102, may be considered indicative of a situation prior to a performance sub-event. The system provider device may interpret that lack of (or few) media generation actions being performed as indicative of no performance sub-event occurring.

In some embodiments, customer device monitoring data retrieved from the customer devices of the plurality of customers 600 that located at the venue 100 for the music event prior to a performance sub-event may also include audio captured (e.g., through actions of the customers or through customer device microphone accessed by the system provider device) at the venue 100. For example, music being played at the venue 100 may be retrieved from one or more of the customer devices (or audio capturing devices set up around the venue 100 by the system provider) and analyzed to determine the songs are being played. As music events may not play songs of any of the performers that are scheduled to perform prior to performance, the system provider device may check whether the songs being played are associated with any performers that are scheduled to perform at the event at the venue 100 (e.g., by referencing the event schedule), and if those songs are not associated with any of those performers, it may be determined that no performance sub-event is occurring. In some embodiment, rather than the retrieval of audio, the system provider device may retrieve text based music identifications from the venue operator that may be checked against an event schedule to determine that the music being played is not associated with a performance sub-event at the event. In the event that the music at the venue 100 prior to a performance sub-event is identified in these or other manners, the music analyzed may be catalogued and offered to the customers 600 for purchase (e.g., as single songs, as a list of songs, etc.).

In some embodiments, customer device monitoring data retrieved from the customer devices of the plurality of customers 600 that located at the venue 100 for the music event prior to a performance sub-event may also include a lack of movement of the customers 600 (e.g., as measured by acceleration sensors in the customer devices), particularly, for example, in the standing area 106 next to the stage. Such a lack of movement may be indicative of a lack of dancing to a performance sub-event. In some embodiments, customer device monitoring data retrieved from the customer devices of the plurality of customers 600 that located at the venue 100 for the music event prior to a performance sub-event may also include a lack of increased temperature or decreased light (e.g., as measured by temperature sensors or light sensor in the customer devices), particularly, for example, in the standing area 106 next to the stage. Such a lack of increased temperature or decreased light may be indicative of a lack of customers located adjacent each other next to the stage for a performance sub-event or of the lights in the venue 100 being dimmed for a performance sub-event. While a few examples of customer device monitoring data have been provided that are indicative of no performance sub-event occurring, one of skill in the art in possession of the present disclosure will recognize that a wide variety of customer device monitoring data may be indicative of no performance sub-event occurring and will fall within the scope of the present disclosure. Furthermore, one of skill in the art in possession of the present disclosure will also recognize that customer device monitoring data that is indicative of no sub-event occurring will change based on the event that is occurring, and will still fall within the scope of the present disclosure.

FIG. 6c illustrates a schematic visualization of a plurality of customer device monitoring data received by the system provider device from the plurality of customers 600 at the venue 100 that is indicative of the plurality of customers 600 being located at the venue 100 for the music event upon the occurrence of a performance sub-event. In the illustrated embodiment, the customer device monitoring data includes location data 602 and orientation data 604 from each customer device associated with a respective customer 600. As can be seen, the location data 602 indicates that many of the customers 600 are located in the seating area 104 and standing area 106 near the stage 102. As can also be seen, the orientation data 604 indicates that many of the customers 600 are oriented towards the stage 102. The system provider device may interpret such location data 602 and orientation data 604 as sub-event start actions performed by a subset of the customer devices of the customers 600. As such, any number (i.e., subset) of the customer devices of the customers 600 may provide location data 602 and orientation data 604 that is detected by the system provider device and interpreted as a sub-event start action at block 404.

In some embodiments, customer device monitoring data retrieved from the customer devices of the plurality of customers 600 that located at the venue 100 for the music event upon the occurrence of a performance sub-event may include media generation actions being performed by the subset of customer devices of the plurality of customers 600. FIG. 6d illustrates a subset of the plurality of customers 600 performing a media generation action (e.g., capturing an image/video/audio with their user devices 600a) upon a performer 606 coming on to the stage 102. The system provider device may interpret such media generation actions as sub-event start actions performed by a subset of the customer devices of the customers 600. As such, any number (i.e., subset) of the customer devices of the customers 600 may perform media generation actions detected by the system provider device and interpreted as a sub-event start action at block 404.

In some embodiments, customer device monitoring data retrieved from the customer devices of the plurality of customers 600 that located at the venue 100 for the music event upon the occurrence of a performance sub-event may also include audio captured (e.g., through actions of the customers or through customer device microphone access by the system provider device) at the venue 100. For example, music being played at the venue 100 may be retrieved from one or more of the customer devices (or audio capturing devices set up around the venue 100 by the system provider) and analyzed to determine the songs being played. As music events may not play songs of any of the performers that are scheduled to perform prior to performance, the system provider device may check whether the songs being played are associated with any performers that are scheduled to perform at the event at the venue 100, and if those songs are associated with any of those performers, it may be determined that a performance sub-event is occurring. The system provider device may interpret any received songs that are associated with any of the performers that are scheduled at the event as sub-event start actions performed by a subset of the customer devices of the customers 600. As such, any number (i.e., subset) of the customer devices of the customers 600 may capture songs that are detected by the system provider device and interpreted as a sub-event start action at block 404.

In some embodiments, customer device monitoring data retrieved from the customer devices of the plurality of customers 600 that located at the venue 100 for the music event upon the occurrence of a performance sub-event may also include an increase in movement of the customers 600 (e.g., as measured by acceleration sensors in the customer devices), particularly, for example, in the standing area 106 next to the stage. Such an increase in movement may be indicative of dancing to a performance sub-event, and the system provider device may interpret the increase in movement as sub-event start actions performed by a subset of the customer devices of the customers 600. As such, any number (i.e., subset) of the customer devices of the customers 600 may indicate an increase in movement (particularly, in the illustrated embodiment, in the standing area 106 near the stage 102) that is detected by the system provider device and interpreted as a sub-event start action at block 404.

In some embodiments, customer device monitoring data retrieved from the customer devices of the plurality of customers 600 that located at the venue 100 for the music event upon the occurrence of a performance sub-event may also include an increased temperature or decrease in light (e.g., as measured by temperature sensors or light sensor in the customer devices), particularly, for example, in the standing area 106 next to the stage. Such an increased temperature or decrease in light may be indicative of customers located adjacent each other next to the stage 102 for a performance sub-event or of the lights in the venue 100 being dimmed for a performance sub-event. The system provider device may interpret any increase in temperature or decrease in light as sub-event start actions performed by a subset of the customer devices of the customers 600. As such, any number (i.e., subset) of the customer devices of the customers 600 may capture increases in temperature or decreases in light that are detected by the system provider device and interpreted as a sub-event start action at block 404.

While a few examples of customer device monitoring data have been provided that are indicative of a performance sub-event occurring, one of skill in the art in possession of the present disclosure will recognize that a wide variety of customer device monitoring data may be indicative of a performance sub-event occurring and will fall within the scope of the present disclosure. Furthermore, one of skill in the art in possession of the present disclosure will also recognize that customer device monitoring data that is indicative of a sub-event occurring will change based on the event that is occurring, and will still fall within in the scope of the present disclosure.

Any data collected during the monitoring of customer devices at block 402 and the detection of sub-event start actions at block 404 may be analyzed in real-time, or saved in the database and analyzed at a later date, in order to determine when a sub-event has started at a sub-event start time, discussed in further detail below. For example, the data collected may be analyzed in real time to determine when a sub-event is starting, and that data may be used to provide notifications to customers that the sub-event is starting. In another example, the data collected may be analyzed after the event has occurred to determine when one or more sub-events occurred such that historical data for the venue, the event, and/or sub-event may be determined, stored, and used for subsequent venues, events, and sub-events to provide notifications to customers attending the subsequent venues, events, and sub-events.

The method 400 then proceeds to block 406 where it is determined that the subset of the plurality of customer devices exceeds a minimum number of customer devices. In embodiment of block 406, the system provider device determines whether the subset of customer devices, which were detected as performing the sub-event start action at block 404, exceeds a minimum number of customer devices. The minimum number of customer devices performing the sub-event start action that are needed in the method 400 to determine that a sub-event has started may vary based on the type of sub-event being detected, the location of the customer devices in the venue 100, and/or a variety of other sub-event start factors. For example, the system provider may require sub-event start actions based on location, orientation, media generation actions, and/or other sub-event start actions to be performed by over half of the customer devices being monitored. In another example, the system provider may require sub-event start actions based on movement and/or temperature to be performed by over 20%, over half, or some other predetermined percentage of the customer devices being monitored as long as those customer devices are located in the standing area 106 next to the stage 102. In yet another example, the system provider may require sub-event start actions based on decreases in light to be performed by most or all of the customer devices being monitored. While a few examples are provided for the number of customer devices in the subset of customer devices that exceeds the minimum number of customer devices, one of skill in the art in possession of the present disclosure will recognize that any variety of factors may be considered in determining what minimum number of customer devices is sufficient to determine that a sub-event start action performed by that minimum number of customer devices is indicative of the starting of a sub-event included in the event.

Furthermore, subsets of customer devices of different numbers performing a sub-event start action may be interpreted as indicative of which of a plurality of sub-events in the event have started. For example, a first subset of customer devices performing a media generation action at a first time during the event may be less than a second subset of the customer devices performing a media generation action at a second time during the event. In such an example, the media generation action performed by the first subset of customer devices may be indicative of an opening act at the event, while the media generation action performed by the second subset of customer devices may be indicative of a main attraction at the event. Thus, the minimum number of the subset of customer devices that perform a sub-event start action may be dynamic or may change within the event such that different sub-events may be determined that are related to how many customer devices performed the sub-event start action.

The method 400 then proceeds to block 408 where a sub-event is determined to have started at a sub-event start time, and that sub-event start time is stored in a database. In an embodiment, the system provider device may utilize a plurality of different information to determine that a sub-event has started at a sub-event start time, just a few examples of which are provided below. In different embodiments, the sub-event start time determined at block 408 and discussed below may include a time or a time range. For example, the system provider device may estimate a time that the sub-event has started based on the timing of the sub-event start actions performed by the subset of customer devices at block 404 (e.g., a first sub-event start action may denote a sub-event start time if it is followed by a minimum number of subsequent sub-event start actions; a sub-event start time may be determined to be in the middle of the occurrence of the sub-event start actions from the subset of customer devices that exceeds the minimum number of customer devices, etc.). In another example, the system provider device may estimate a time that the sub-event has started based on information included in a sub-event start action (e.g., a timestamp on an image, in a video, in audio, etc.). In another example, the system provider device may determine a time range in which the sub-event has started based on the timing of the sub-event start actions performed by the subset of customer devices at block 404 (e.g., a first sub-event start action may denote a beginning of the time range and a last sub-event start action that provides a minimum number of sub-event event start actions may denote the end of the time range). While a few examples are provided, any of a variety of methods for determining a sub-event start time based on the sub-event start actions are envisioned as falling within the scope of the present disclosure.

In one embodiment, the sub-event that has started is determined using an event schedule that was retrieved from the event/sub-event data 508b in the event database, that was scanned using optical character recognition techniques, and/or that was provided to the system provider device using a variety of other methods known in the art. For example, the event schedule for the event at the venue 100 may include a scheduled start time and a single performance sub-event, and at block 408 the system provider device may determine that the sub-event start actions are indicative of the start of the performance sub-event (which, in many examples will be some time after the scheduled start time). In some examples, even when the event schedule does not indicate the performance sub-event, the sub-event start actions may include information that allows the system provider device to determine what that sub-event is. For example, a performer for a musical performance sub-event may be determined using audio retrieved from the customer devices (e.g., by matching the retrieved audio with audio from the performer in a database), images or video retrieved from the customer devices (e.g., by matching the retrieved images or video with images or video from the performer in a database), etc.

In another example, the event schedule for the event at the venue 100 may include at least one scheduled start time and a plurality of performance sub-events, and at block 408 the system provider device may determine that the sub-event start actions are indicative of the start of one of the performance sub-events. For example, the event schedule may indicate the scheduled start times for each of the sub-events, and the sub-event start time may be determined to be for a sub-event that was scheduled closest in time to that sub-event start time. In another example, the relative number of sub-event start actions detected may be used to determine which of a plurality of sub-events should be associated with the sub-event start time (e.g., there will be more sub-event start actions such as image/video capturing for an event main attraction relative to other performers at an event, and thus different performance sub-events in an event may be associated with sub-event start times based on the number of sub-event start actions that were detected to determine those sub-event start times).

Furthermore, any of the data collected from the customer devices may be used together to provide a confirmation that a sub-event has started. For example, media generation actions may be considered indicative of the start of a sub-event, and then location data, orientation data, light sensor data, and/or other data may be used to confirm that sub-event (that was detected using the media generation actions) has started. One of skill in the art will recognize that any data or combination of data discussed above (e.g., location data and orientation data) may be considered primary data that may be confirmed with secondary data while remaining within the scope of the present disclosure.

Thus, the system provider device may determine one or more sub-event start times for respective sub-events that are included in the event at the venue. As is known in the art, events and their sub-events may not start at their scheduled start times, and the systems and methods of the present disclosure may be used to determine when an event and/or its sub-events have actually started. The sub-event start time or start times determined at block 408 may then be stored by the system provider device in a database. The system provider device may store the sub-event start times in the database in association with the event, their scheduled start times, the performer of the event, the venue, and/or any other information associated with the event. As such, the database used by the system provider device will store event/sub-event data in the event database 508a that indicates when the sub-events included in the event started relative to their scheduled time, and may link that information with venues, events, performers, dates and time, and/or any other information associated with the those sub-events.

The method 400 then proceeds to block 410 where an average sub-event start time is determined using the sub-event start time and previously determined sub-event start times. In an embodiment, blocks 402-408 may be performed for any number of occurrences of any number of events across any number of venues. As such, the event database 508 may be filled with sub-event start times that have been determined for multiple occurrences of an event, sub-event start times that have been determined for multiple performances by a performer at one or more different events, sub-event start times for multiple different events that have occurred at a venue, etc. This allows the system provider device to determine an average sub-event start time based on any of the variety of factors discussed above including the event, the sub-event (at the event or during other events), the venue (for the event or other events), etc.

In an embodiment of block 410, the system provider device may determine an average sub-event start time using the start time determined at block 408 and a plurality of a previously determined sub-event start times. For example, the system provider device may determine the average sub-event start time based on the occurrence of the event at a plurality of different venues (e.g., a first sub-event included in the event typically starts 10 minutes after its scheduled start time, regardless of which venue it occurs at or at the venue it is occurring at), based on the performer associated with the sub-event (e.g., the performer providing the performance sub-event typically starts 25 minutes after their scheduled start time regardless of what event or venue they are performing at, at the event they are performing at, at the venue they are performing at), based on the venue 100 (e.g., sub-events at the venue typically start 13 minutes after their scheduled start time regardless of the event or for the event that is occurring), combinations thereof, and/or considering any other factors collected and analyzed by the system provider device during the method 400. One of skill in the art will recognize that the average sub-event start times for sub-events may be updated whenever the event or sub-event occurs, and the more data that is acquired to determine the average sub-event start time, the more accurate that average sub-event start time will become.

The method 400 then proceeds to block 412 where the average sub-event start time is used to estimate a sub-event start time for a subsequent event occurrence. In an embodiment, subsequent occurrences of the event may allow for the system provider device to estimate sub-event start time(s) for that subsequent event occurrence and, for example, provide the estimated sub-event start time(s) to customers or potential customers. While a few examples are provided below, one of skill in the art in possession of the present disclosure will recognize that estimated sub-event start times may be provided in a variety of manners that will fall within the scope of the present disclosure.

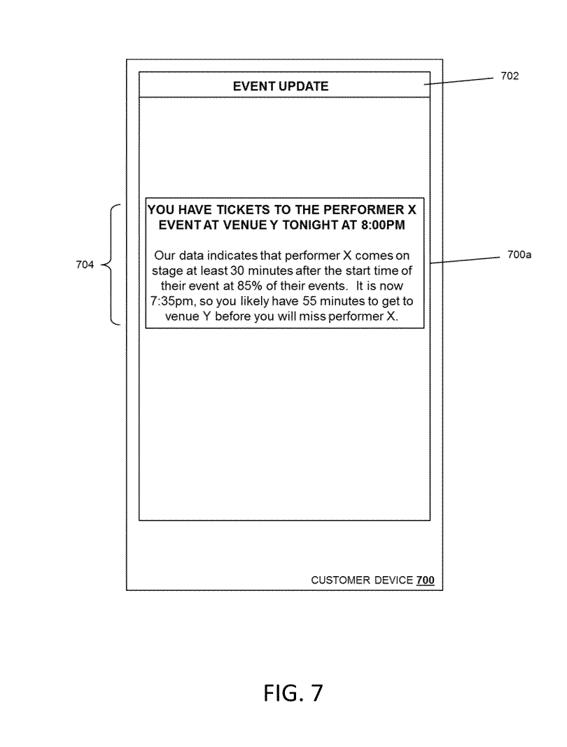

FIG. 7 illustrates a customer device 700 that includes a display 700a displaying an event update screen 702 that is sent from the system provider device to the customer device 700 using the estimated sub-event start time discussed above. In an embodiment, the customer device 700 is associated with a customer that has purchased tickets to a subsequent performance of an event or sub-event (e.g., at the venue 100, at a different venue, etc.), and the system provider device has determined that the customer will be attending the event or sub-event (e.g., based on event ticketing data in a database) and, in response, has sent an event update 704 that is displayed on the event update screen 702. In an embodiment, the event update screen 702 may be provided in an application running on the customer device 700, as a pop-up window on the customer device 700, as a text message or email on the customer device 700, and/or in any other manner known in the art. The event update 704 indicates to the user that they are attending the event at a venue that includes a performance sub-event by performer X that is scheduled to start at 8:00 pm. However, the event update also includes information determined using the estimated sub-event start time that indicates to the user that performance sub-events by performer X typically start 30 minutes after their scheduled start time 85% of the time, along with a current time (e.g., 7:35 pm) and an estimated amount of time (e.g., in 55 minutes) that the customer has to get to venue Y to see the start of performer X's performance sub-event. In different embodiments, the event update may provide degrees of confidence of the estimate sub-event start times (e.g., “there is an 85% chance that performer X will start 30 minutes after the scheduled start time, a 50% chance that performer X will start 45 minutes after the scheduled start time, and a 25% chance that performer X will start 60 minutes after the scheduled start time.”).

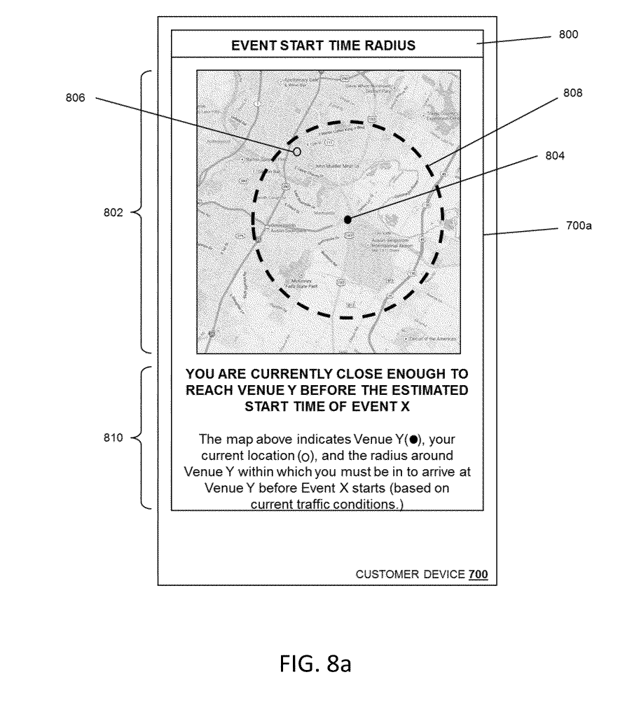

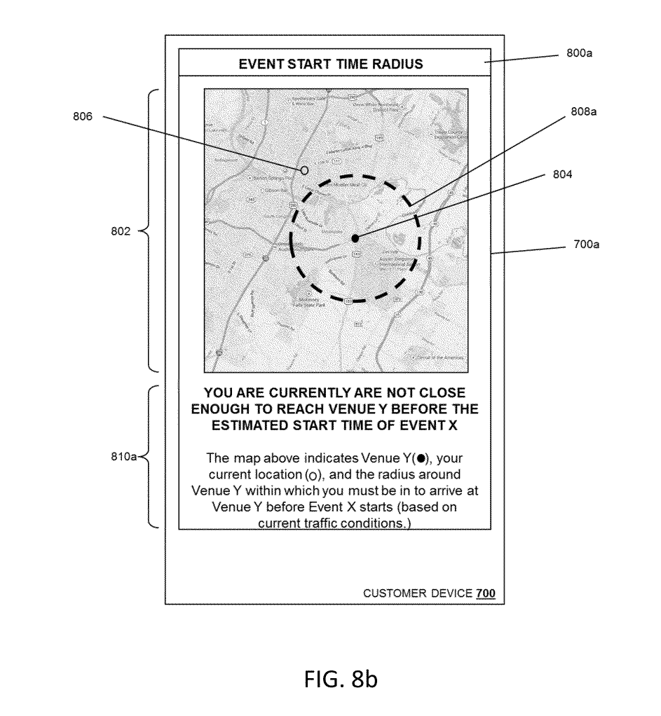

Referring now to FIGS. 8a and 8b, another embodiment of the use of the estimated sub-event start time is illustrated. In the illustrated embodiment, the system provider device may use the estimated sub-event start time, along with the location of the venue (e.g., retrieved from the venue data 508a) and the current location of the customer device 700 to provide a customer with a visualization of the estimated sub-event start time with regard to their relative distance to the venue. In the illustrated embodiment, the display device 700a on the customer device 700 is illustrated displaying an event update screen 800 that includes a map 802 having a venue indicator 804 that is positioned relative to the map 802 using information about the location of the venue, a customer indicator 806 that is positioned relative to the map 802 using information about the location of the customer, and an venue perimeter 808 that is centered around the venue indicator 804 and that includes a size that may be determined using the estimated sub-event start time and the current traffic conditions such that it is indicative of a perimeter around the venue within which the current traffic conditions will allow one to reach the venue before the estimated sub-event start time (while the estimated sub-event start time venue perimeter 808 is illustrated as circular, any shape (including those based on the roads displayed on the map 802) is envisioned as falling within the scope of the present disclosure.)

In the embodiment illustrated in FIG. 8a, the event update screen 800 also includes an informational section 810 that informs the customer they are close enough to reach the venue by the estimated sub-event start time due to their current location being within the estimated sub-event start time venue perimeter 808. However, as the time prior to the estimated sub-event start time decreases, the venue perimeter 808 may be decreased as well to indicate that there is less time to reach the venue prior to the actual start time of the event or sub-event. For example, in the embodiment illustrated in FIG. 8b, an event update screen 800a is provided that is substantially the same as the event update screen 800 but with a modified venue perimeter 808a and informational section 810a that informs the customer they are no longer close enough to reach the venue by the estimated sub-event start time due to their current location being outside of the venue perimeter 808. Thus, a customer within the venue perimeter may judge how soon they need to leave for the venue to ensure that they will not miss the sub-event that is estimated to start at the estimated sub-event start time, while a customer near or outside the venue perimeter will understand that they need to leave for the venue immediately to ensure that they will not miss the sub-event that is estimated to start at the estimated sub-event start time.

The use of the estimated event start time by the system provider and customers may be expanded in a variety of manners. In an embodiment, users that have not purchased a ticket to an event may be shown the estimated sub-event start time or venue perimeter 808 discussed above (e.g., on an application on their user device) to be alerted that there is an event in their location that is past its scheduled start time, but that has a sub-event start time that they may be able to make it to the venue in time for. In another embodiment, the estimated sub-event start time may be used to suggest modes of transportation to the venue at which the event is occurring. For example, if the estimated sub-event start time is far enough away or a customer is well within the venue perimeter 808 discussed above, the system provider device may suggest that the customer use slower modes of transportation such as buses, biking, or walking, while if the estimated sub-event start time is close or customer is outside of the venue perimeter 808 discussed above, the system provider device may suggest that the customer use faster modes of transportation such as cars or a taxi cab. As such, the estimated sub-event start time may be used to save customers money in transportation choices that will still allow the customer to arrive before the estimated sub-event start time.

In another embodiment, the estimated sub-event start time may be used to suggest parking choices to customers. For example, the system provider device may access a layout of the parking areas for the venue (e.g., in the venue data 508a), and as the estimated sub-event start time gets closer or the venue perimeter 808 discussed above gets smaller, the system provider device may recommend closer parking spaces (e.g., from parking lots outside of the venue, to parking lots inside of the venue, to a valet service at the front of the venue) such that the customer does not miss the start of the event. As such, the estimated sub-event start time may be used to save customers money in parking choices that will still allow the customer to arrive before the estimated sub-event start time.

In embodiments where the estimated sub-event start time indicates that the customer has sufficient time before the estimated sub-event start time, the system provider device may suggest one or more areas of interest to the customer that are near or on the way to the venue. For example, the system provider device may determine one or more restaurants that are near or on the way to the venue and suggest those restaurants to the customer if the time until the estimated sub-event start time indicates that the customer will have sufficient time to visit the restaurant and still arrive at the venue prior to the sub-event start time. In some examples, the system provider device may operate to reserve a table at a restaurant if the customer indicates that they would like to visit the restaurant prior to arriving at the venue.

Thus, systems and methods have been described that allow for a system provider to estimate sub-event start times for sub-events that are included in an event. The system provider utilizes information retrieved from customer devices of customers at events to determine when sub-event start time actions that are indicative of the start of a sub-event are performed. Over multiple occurrences of the event or sub-event, the system provider may determine average sub-event start times for the sub-events included in the event, which allows the system provider to inform users of when sub-events of an event will actually occur during subsequent occurrences of the event or sub-event, and provides those customers the ability to more efficiently use their time and resources between the scheduled start time of an event and the actual start time of a sub-event in that event that they are interested in attending.

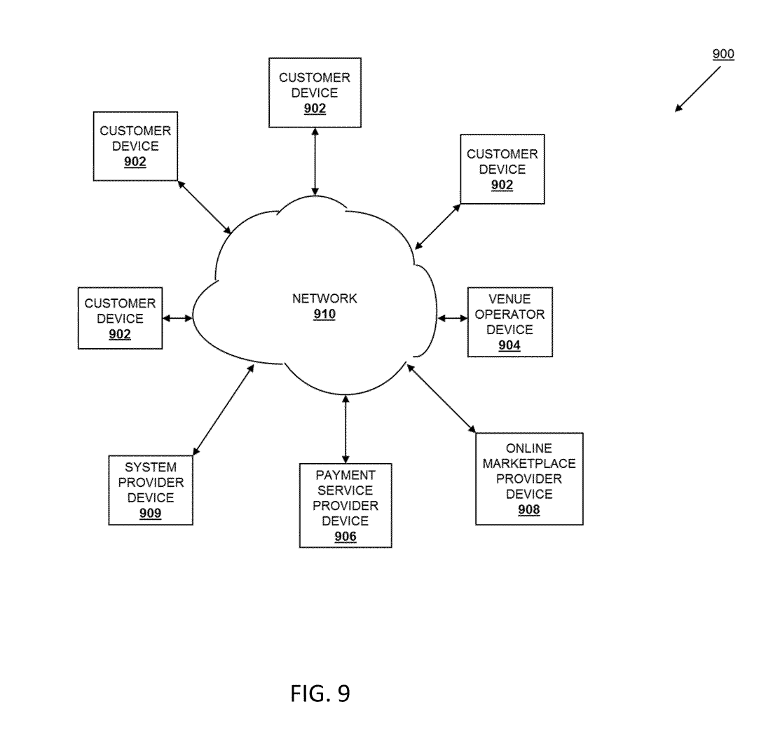

Referring now to FIG. 9, an embodiment of a network-based system 900 for implementing one or more processes described herein is illustrated. As shown, the network-based system 900 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 9 may be deployed in other ways and that the operations performed and/or the services provided by such servers may be combined or separated for a given implementation and may be performed by a greater number or fewer number of servers. One or more servers may be operated and/or maintained by the same or different entities.

The embodiment of the networked system 900 illustrated in FIG. 9 includes a plurality of customer devices 902, a venue operator device 904 (which may include the plurality of beacon devices discussed above), a payment service provider device 906, an online marketplace provider device 908, and/or a system provider device 909 in communication over one or more networks 910. The customer devices 902 may be the customer devices discussed above and may be operated by the customers discussed above. The venue operator device 904 and beacon devices may be the venue operator devices and beacon devices discussed above and may be operated by the venue operators discussed above. The payment service provider device 906 may be the payment service provider devices discussed above and may be operated by a payment service provider such as, for example, PayPal Inc. of San Jose, Calif. The online marketplace provider device 908 may be the online marketplace provider devices discussed above and may be operated by a online marketplace provider such as, for example, StubHub, a subsidiary of EBay, Inc. of San Jose, Calif. The system provider devices 909 may be the system provider devices discussed above and may be operated by the system providers discussed above.

The customer devices, a venue operator device, a payment service provider device, online marketplace provider device, and/or a system provider device may each include one or more processors, memories, and other appropriate components for executing instructions such as program code and/or data stored on one or more computer readable mediums to implement the various applications, data, and steps described herein. For example, such instructions may be stored in one or more computer readable mediums such as memories or data storage devices internal and/or external to various components of the system 900, and/or accessible over the network 910.

The network 910 may be implemented as a single network or a combination of multiple networks. For example, in various embodiments, the network 910 may include the Internet and/or one or more intranets, landline networks, wireless networks, and/or other appropriate types of networks.

The customer devices 902 may be implemented using any appropriate combination of hardware and/or software configured for wired and/or wireless communication over network 910. For example, in one embodiment, the customer devices 902 may be implemented as a personal computer of a customer in communication with the Internet. In other embodiments, the customer devices 902 may be a smart phone, personal digital assistant (PDA), laptop computer, and/or other types of computing devices.

The customer devices 902 may include one or more browser applications which may be used, for example, to provide a convenient interface to permit the customer to browse information available over the network 910. For example, in one embodiment, the browser application may be implemented as a web browser configured to view information available over the Internet.

The customer devices 902 may also include one or more toolbar applications which may be used, for example, to provide customer-side processing for performing desired tasks in response to operations selected by the customer. In one embodiment, the toolbar application may display a customer interface in connection with the browser application.

The customer devices 902 may further include other applications as may be desired in particular embodiments to provide desired features to the customer devices 902. In particular, the other applications may include a payment application for payments assisted by a payment service provider through the payment service provider device 906. The other applications may also include security applications for implementing customer-side security features, programmatic customer applications for interfacing with appropriate application programming interfaces (APIs) over the network 910, or other types of applications. Email and/or text applications may also be included, which allow customer payer to send and receive emails and/or text messages through the network 910. The customer devices 902 includes one or more customer and/or device identifiers which may be implemented, for example, as operating system registry entries, cookies associated with the browser application, identifiers associated with hardware of the customer devices 902, or other appropriate identifiers, such as a phone number. In one embodiment, the customer identifier may be used by the payment service provider device 906 to associate the customer with a particular account as further described herein.

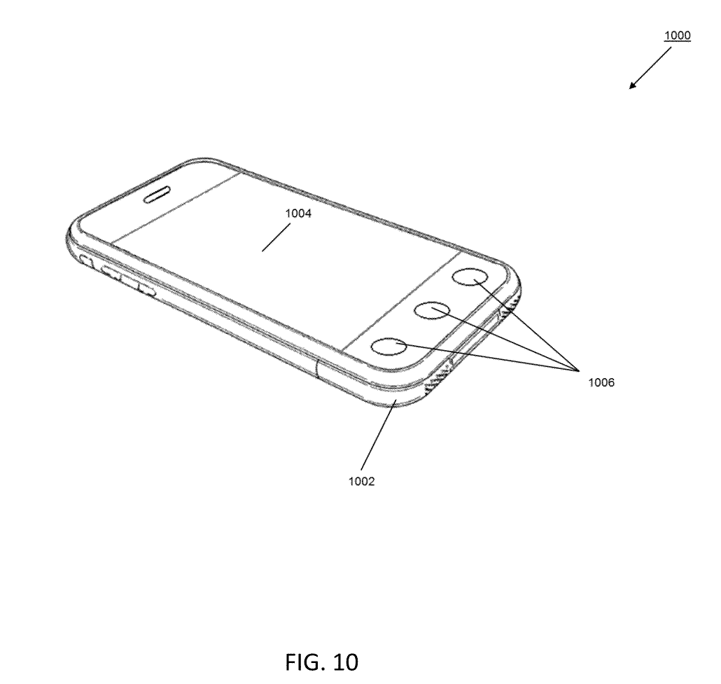

Referring now to FIG. 10, an embodiment of a customer device 1000 is illustrated. The customer device 1000 may be the customer devices discussed above. The customer device 1000 includes a chassis 1002 having a display 1004 and an input device including the display 1004 and a plurality of input buttons 1006. One of skill in the art will recognize that the customer device 1000 is a portable or mobile phone including a touch screen input device and a plurality of input buttons that allow the functionality discussed above with reference to the methods above. However, a variety of other portable/mobile customer devices and/or desktop customer devices may be used in the methods discussed above without departing from the scope of the present disclosure.

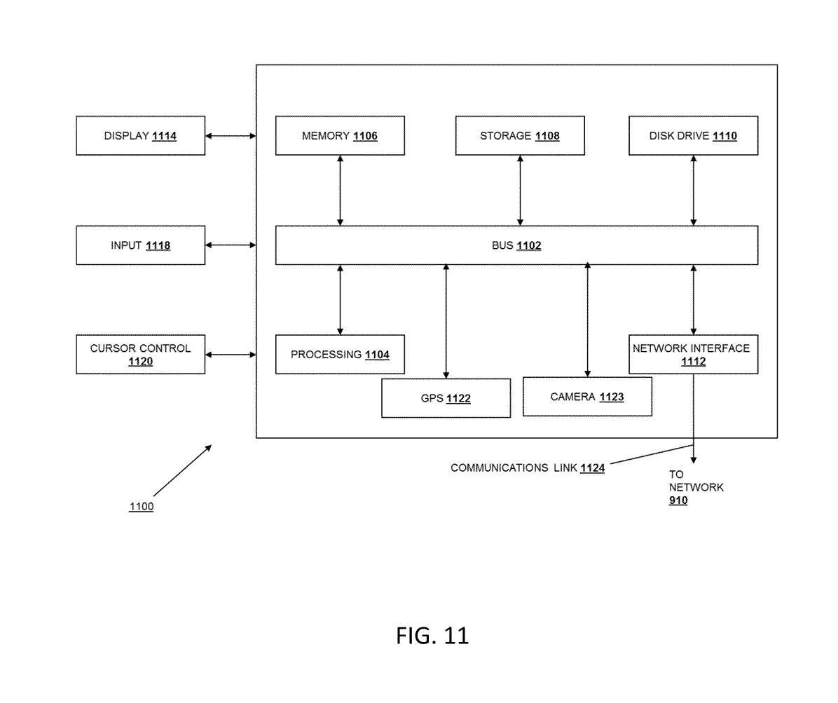

Referring now to FIG. 11, an embodiment of a computer system 1100 suitable for implementing, for example, the customer devices, venue operator device, payment service provider device, online marketplace provider device, and/or system provider device, is illustrated. It should be appreciated that other devices utilized by customers, venue operators, payment service providers, online marketplace providers, and/or system providers in the system discussed above may be implemented as the computer system 1100 in a manner as follows.

In accordance with various embodiments of the present disclosure, computer system 1100, such as a computer and/or a network server, includes a bus 1102 or other communication mechanism for communicating information, which interconnects subsystems and components, such as a processing component 1104 (e.g., processor, micro-controller, digital signal processor (DSP), etc.), a system memory component 1106 (e.g., RAM), a static storage component 1108 (e.g., ROM), a disk drive component 1110 (e.g., magnetic or optical), a network interface component 1112 (e.g., modem or Ethernet card), a display component 1114 (e.g., CRT or LCD), an input component 1118 (e.g., keyboard, keypad, or virtual keyboard), a cursor control component 1120 (e.g., mouse, pointer, or trackball), a location determination component 1122 (e.g., a Global Positioning System (GPS) device as illustrated, a cell tower triangulation device, and/or a variety of other location determination devices known in the art), and/or a camera component 1123. In one implementation, the disk drive component 1110 may comprise a database having one or more disk drive components.

In accordance with embodiments of the present disclosure, the computer system 1100 performs specific operations by the processor 1104 executing one or more sequences of instructions contained in the memory component 1106, such as described herein with respect to the customer devices, merchant devices, beacon devices, merchant beacon communication devices, payment service provider device, and/or system provider device. Such instructions may be read into the system memory component 1106 from another computer readable medium, such as the static storage component 1108 or the disk drive component 1110. In other embodiments, hard-wired circuitry may be used in place of or in combination with software instructions to implement the present disclosure.

Logic may be encoded in a computer readable medium, which may refer to any medium that participates in providing instructions to the processor 1104 for execution. Such a medium may take many forms, including but not limited to, non-volatile media, volatile media, and transmission media. In one embodiment, the computer readable medium is non-transitory. In various implementations, non-volatile media includes optical or magnetic disks, such as the disk drive component 1110, volatile media includes dynamic memory, such as the system memory component 1106, and transmission media includes coaxial cables, copper wire, and fiber optics, including wires that comprise the bus 1102. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. In one embodiment, the computer readable media is non-transitory.

In various embodiments of the present disclosure, execution of instruction sequences to practice the present disclosure may be performed by the computer system 1100. In various other embodiments of the present disclosure, a plurality of the computer systems 1100 coupled by a communication link 1124 to the network 910 (e.g., such as a LAN, WLAN, PTSN, and/or various other wired or wireless networks, including telecommunications, mobile, and cellular phone networks) may perform instruction sequences to practice the present disclosure in coordination with one another.

The computer system 1100 may transmit and receive messages, data, information and instructions, including one or more programs (i.e., application code) through the communication link 1124 and the network interface component 1112. The network interface component 1112 may include an antenna, either separate or integrated, to enable transmission and reception via the communication link 1124. Received program code may be executed by processor 1104 as received and/or stored in disk drive component 1110 or some other non-volatile storage component for execution.

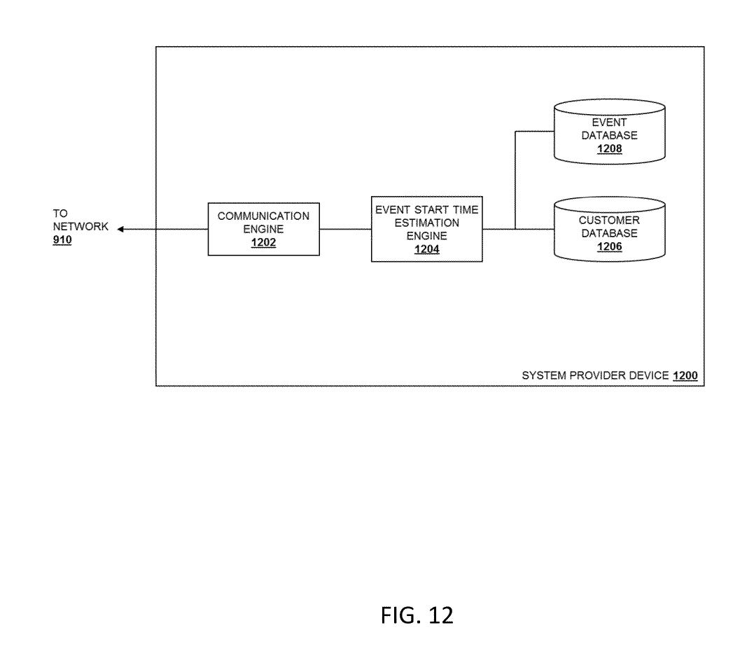

Referring now to FIG. 12, an embodiment of a system provider device 1200 is illustrated. In an embodiment, the device 1200 may be the system provider device discussed above. The device 1200 includes a communication engine 1202 that is coupled to the network 910 and to an event start time estimation engine 1204 that is coupled to a customer database 1206 and an event database 1208. The communication engine 1202 may be software or instructions stored on a computer-readable medium that allows the device 1200 to send and receive information over the network 910. The event start time estimation engine 1204 may be software or instructions stored on a computer-readable medium that is configured to monitor customer devices, detect sub-event start actions, determine whether a subset of customer devices that have performed a sub-event start action is greater than a minimum number of customer devices, determine a sub-event has started at a sub-event start time, store the sub-event start time in a database, determine an average sub-event start time, use the average sub-event start time to estimate a sub-event start time for an event, use the estimated sub-event start time in the variety of manners discussed above, as well as provide any of the other functionality that is discussed above. While the databases 1206 and 1208 are illustrated as located in the device 1200, one of skill in the art will recognize that they may be connected to the event start time estimation engine 1204 through the network 910 without departing from the scope of the present disclosure.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, the above embodiments have focused on merchants and customers; however, a customer or consumer can pay, or otherwise interact with any type of recipient, including charities and individuals. The payment does not have to involve a purchase, but may be a loan, a charitable contribution, a gift, etc. Thus, merchant as used herein can also include charities, individuals, and any other entity or person receiving a payment from a customer. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. An event start time estimation system, comprising:
a non-transitory memory storing information about an event that includes a sub-event;
one or more hardware processors coupled to the memory and operable to read instructions from the memory to perform the steps of:
monitoring a plurality of customer devices that are located at a venue at which the event is scheduled to occur;
detecting that a media generation action has been performed within a time period on a subset of the plurality of customer devices;
determining that the subset of the plurality of customer devices that has performed the media generation action exceeds a minimum number of customer devices and, in response, determining that the sub-event has started at a sub-event start time;
storing the sub-event start time in a database.

2. The system of claim 1, wherein the media generation action is associated with an image capturing device on each of the subset of the plurality of customer devices.

3. The system of claim 1, wherein the information about the event that includes the sub-event includes a scheduled start time and a main attraction, and wherein the sub-event start time is associated with the main attraction in the database.

4. The system of claim 1, wherein the sub-event start time is stored in the database in association with a plurality of previously determined sub-event start times for the sub-event, and wherein the one or more hardware processors are operable to read instructions from the memory to perform the steps of:
determining an average sub-event start time for the sub-event using the sub-event start time and the plurality of previously determined sub-event start times.

5. The system of claim 4, wherein the one or more hardware processors are further operable to read instructions from the memory to perform the steps of:
determining, for a subsequent occurrence of the event that is associated with a subsequent venue, that a subsequent event customer device is at a first location that is outside of the subsequent venue;
determining an estimated sub-event start time for the subsequent occurrence of the event using the average sub-event start time and the information about the event; and
providing the estimated sub-event start time for display on the subsequent event customer device.

6. The system of claim 5, wherein the estimated sub-event start time that is provided for display on the subsequent event customer device is provided in association with a map that includes the first location and the subsequent venue.

7. A method for estimating event start times, comprising:
monitoring, by a system provider device over at least one network, a plurality of customer devices that are located at a venue at which an event that includes at least one sub-event is scheduled to occur;
detecting, by the system provider device over the at least one network, that a media generation action has been performed within a time period on a subset of the plurality of customer devices;
determining, by the system provider device, that the subset of the plurality of customer devices that has performed the media generation action exceeds a minimum number of customer devices and, in response, determining, by the system provider device, that the sub-event has started at a sub-event start time;
storing, by the system provider device, the sub-event start time in a database.

8. The method of claim 7, wherein the media generation action is associated with an audio capturing device on each of the subset of the plurality of customer devices.

9. The method of claim 7, wherein the event that includes the sub-event includes a scheduled start time, a main attraction, and at least one secondary attraction, and wherein the sub-event start time is associated with the at least one secondary attraction in the database.

10. The method of claim 7, wherein the sub-event start time is stored, by the system provider device, in the database in association with a plurality of previously determined sub-event start times for the sub-event, and wherein the method further comprises:
determining, by the system provider device, an average sub-event start time for the sub-event using the sub-event start time and the plurality of previously determined sub-event start times.

11. The method of claim 10, further comprising:
determining, by the system provider device over the at least one network for a subsequent occurrence of the event that is associated with a subsequent venue, that a subsequent event customer device is at a first location that is outside of the subsequent venue;
determining, by the system provider device, an estimated sub-event start time for the subsequent occurrence of the event using the average sub-event start time and information about the sub-event included in the event; and
providing, by the system provider device over the at least one network, the estimated sub-event start time for display on the subsequent event customer device.

12. The method of claim 11, wherein the estimated sub-event start time that is provided for display on the subsequent event customer device is provided in association with a map that includes the first location and the subsequent venue.

13. The method of claim 12, further comprising:
providing a perimeter around the subsequent venue on the map, wherein the perimeter varies as a function of an amount of time until the estimated sub-event start time.

14. A non-transitory computer-readable medium comprising instructions which, in response to execution by a computer system, cause the computer system to perform a method comprising:
monitoring a plurality of customer devices that are located at a venue at which an event that includes at least one sub-event is scheduled to occur;
detecting that a media generation action has been performed within a time period on a subset of the plurality of customer devices;
determining that the subset of the plurality of customer devices that has performed the media generation action exceeds a minimum number of customer devices and, in response, determining that the sub-event has started at a sub-event start time;
storing the sub-event start time in a database.

15. The non-transitory machine-readable medium of claim 14, wherein the media generation action is associated with at least one of an image capturing device and an audio capturing device on each of the subset of the plurality of customer devices.

16. The non-transitory machine-readable medium of claim 14, wherein the event that includes the sub-event includes a main attraction and at least one secondary attraction, and wherein the sub-event start time is associated with the main attraction in the database.

17. The non-transitory machine-readable medium of claim 14, wherein the sub-event start time is stored in the database in association with a plurality of previously determined sub-event start times for the sub-event, and wherein the method further comprises:
determining an average sub-event start time for the sub-event using the sub-event start time and the plurality of previously determined sub-event start times.

18. The non-transitory machine-readable medium of claim 17, wherein the method further comprises:
determining, for a subsequent occurrence of the event that is associated with a subsequent venue, that a subsequent event customer device is at a first location that is outside of the subsequent venue;
determining an estimated sub-event start time for the subsequent occurrence of the event using the average sub-event start time and information about the sub-event included in the event; and
providing the estimated sub-event start time for display on the subsequent event customer device.

19. The non-transitory machine-readable medium of claim 18, wherein the estimated sub-event start time that is provided for display on the subsequent event customer device is provided in association with a map that includes the first location and the subsequent venue.

20. The non-transitory machine-readable medium of claim 17, wherein the method further comprises:
determining an estimated sub-event start time for the subsequent occurrence of the event using the average sub-event start time and information about sub-event included in the event;
determining a transportation mode that will provide for arrival at the venue prior to the estimated sub-event start time; and
sending a recommendation of the transportation mode over the network for display on the subsequent customer device.
